(19) United States
(12) Patent Application Publication
(10) Pub. No.: US 2016/0372738 A1
(43) Pub. Date: Dec. 22, 2016

(54) ELECTRODE FOR AN ELECTROCHEMICAL ENERGY STORE

(71) Applicant: ROBERT BOSCH GMBH, Stuttgart (DE)

(72) Inventors: Henning STOTZ, Musberg (DE); Ulrich SAUTER, Karlsruhe (DE)

(21) Appl. No.: 14/901,268

(22) PCT Filed: Apr. 29, 2014
(86) PCT No.: PCT/EP2014/058639

§ 371 Date: Dec. 28, 2015

(30) Foreign Application Priority Data
Jun. 27, 2013 (DE) 102013212388.4

(51) Int. Cl. H01M 4/1397; H01M 4/136; H01M 4/58; H01M 4/04; H01M 10/0565; H01M 10/0525; H01M 4/62

(52) U.S. Cl. CPC H01M 4/1397; H01M 10/0525; H01M 4/136; H01M 4/625; H01M 4/0404; H01M 4/0435; H01M 10/0565; H01M 4/5815; H01M 2004/021

(57) ABSTRACT

An electrode for an electrochemical energy store is provided, the electrode being situated between a wall, for example a separator, and a current collector, including at least one conductive additive and at least one reactant, the electrode having a gradient at which the volume fraction of the conductive additive decreases from the current collector in the direction of the wall. An energy store equipped with the electrode is further provided, as is a method for manufacturing an electrode, and the use of the energy store equipped with the electrode in an electrical device. As a result, optimal utilization of the electrode is achieved, whereby a higher charging or discharging rate may be achieved at a predefined charging and/or discharging capacity, or a higher charging and/or discharging capacity may be achieved at a given charging or discharging rate of the electrode.

### FIELD OF THE INVENTION

The present invention relates to an electrode for an electrochemical energy store, to an energy store equipped therewith, to a method for manufacturing the electrode, and to the use of the energy store equipped with the electrode in an electronic component.

### BACKGROUND INFORMATION

Electrochemical energy stores, for example lithium-ion batteries, are composed of a positive and a negative electrode, which are connected to each other by an outer circuit and an electrolyte. The outer circuit ensures the electron transport, and the electrolyte ensures the ion transport. The electrolyte may be a solid or a liquid. If the electrolyte is a liquid, this electrolyte is typically made of a solvent in which a so-called conducting salt is present in dissociated form. The two electrodes are typically separated from each other by a so-called separator so that no short circuit may arise.

Moreover, the electrodes are typically composed of porous layers, which are applied to one side or both sides of a thin current collector sheet metal and in which precipitation and dissolution reactions take place, for example in the case of lithium-sulfur electrodes, in which sulfur enters the solution in the liquid electrolyte during the discharging process and sparingly soluble Li2S precipitates in the electrode during the reaction, or in the case of lithium-oxygen electrodes, in which Li2O2 forms in the electrode during the discharging process and then fills a portion of the pore space. These porous layers typically must keep a large pore volume available within the electrode to be able to accommodate the dissolved products in the electrolyte present in the pore space on the one hand, and to be able to accommodate the precipitation products without fully blocking the pore space and thereby preventing a further reaction on the other hand.

### SUMMARY

The subject matter of the present invention relates to an electrode for an electrochemical energy store.

The electrode for an electrochemical energy store, for example a lithium-ion battery, is situated between a wall, for example a separator or a housing wall, and a current collector. The electrode includes at least one conductive additive and at least one reactant, the electrode having a gradient at which the volume fraction of the conductive additive decreases from the current collector in the direction of the wall.

The term separator may describe a position between the positive and negative electrodes, which has the task to spatially and electrically separate the cathode and the anode, i.e., the negative and positive electrodes, in the energy store. However, the separator must be pervious to the ions which effectuate the conversion of the stored chemical energy into electrical energy. The separator is ion-conducting to allow a process to take place in the energy store. The material for a separator in systems including liquid electrolyte is a porous, electrically nonconductive material which is saturated with electrolyte. In systems including solid electrolyte, the separator may either be a dense or porous layer made of a solid ion conductor or a mixture of a solid ion conductor and another electrically nonconductive material, such as a polymer.

The term current collector refers to a carrier which is used to pick up the electrons from the electrochemical reactions taking place in the electrodes of the electrochemical energy store. The current collector may include a metal, for example from the group including aluminum, copper, nickel, gold, stainless steel or a metal alloy of the above-mentioned metals. The material of the current collector may be porous, for example to allow a gas, such as oxygen, to diffuse into the electrode.

The term conductive additive refers to an electrically conductive matrix, typically made of a carbon component, for example carbon black, graphite and/or carbon fibers and/or carbon nanotubes, to increase the electronic conductivity of the electrode, binding agents which mechanically stabilize the structure, for example polymers, and additional inactive components and the finely distributed reactant, for example sulfur in the case of lithium-sulfur electrodes, and oxygen dissolved in the electrolyte in the case of lithium-oxygen electrodes. The conductive additive of the electrode may form a porous structure. The conductive additive may be present in fiber form or else in particulate form. The preferred volume fraction of the conductive additive is 10 vol. % to 25 vol. % of the electrode in the charged state. The preferred volume fraction of the binding agent is 2 vol. % to 6 vol. % of the electrode in the charged state.

The term reactant refers to an active material of the electrode, for example sulfur or oxygen. A chemical reaction is induced in the electrode with the aid of the reactant, whereby electrochemical energy is made available, which may be picked up by the current collector. The reactant may be partially dissolved in the electrolyte. The preferred volume fraction of the reactant is preferably 20 vol. % to 30 vol. % of the electrode in the charged state.

The electrode may be applied to one side or both sides of a current collector, for example with the aid of coating, laminating or printing. For example, in the case of an electrode which is applied to one side, the electrode may be situated between a wall, for example a separator, and a current collector, and in the case of an electrode which is applied to both sides, an additional electrode may be situated between the current collector and a second wall, for example the housing wall, of the electrochemical energy store. The applied electrode on the current collector may have a thickness of greater than 0 μm to less than or equal to 200 μm, preferably a thickness of greater than or equal to 5 μm to less than or equal to 80 μm, and particularly preferably a thickness of greater than or equal to 8 μm to less than or equal to 50 μm. Typical layer widths are a few cm to several 10 cm, and typical coating lengths are several m to several km.

The electrode may be permeated by continuous pores having preferably a low tortuosity, which are filled by electrolyte. The preferred volume fraction of the pores or the porosity is 40 vol. % to 75 vol. % of the electrode in the charged state.

As a result of the formation of a gradient due to the conductive additive decreasing from the current collector in the direction of the wall, the reactants, for example sulfur in the case of lithium-sulfur electrodes, may be distributed during the manufacture of the electrodes in such a way that more reactants are available in areas of high local current density and high ion concentration than in areas of lower current density and lower ion concentration.

At the same time, less conductive additive and thus reaction surface may be made available in areas of high local current density and high ion concentration than in areas of lower current density and lower ion concentration.

In this way, a larger pore space is also provided in areas of high local current density and high ion concentration for accommodating the soluble intermediate products, for example polysulfides in lithium-sulfur cathodes, and of the insoluble precipitation products, for example Li2S in lithium-sulfur electrodes and Li2O2 in lithium-oxygen electrodes. The solids volume of Li25 in the discharged electrode is approximately 25 vol. % greater than the solids volume of the added sulfur. This accordingly decreases the pore volume in the discharged electrode.

An optimal utilization of the electrode may be achieved in such a way that a larger amount of reactants is present at locations of increased reaction rate during the charging and discharging process, and at the same time more space is kept available for the accommodation of soluble and insoluble products. In this way, simultaneously a local clogging of the electrode in the vicinity of the wall may be prevented and a higher charging or discharging rate may be achieved at a predefined charging and/or discharging capacity, or a higher charging and/or discharging capacity may be achieved at a given charging or discharging rate of the electrode.

The volume fraction-related distribution of the conductive additive advantageously takes place with the aid of a multi-layer composition, each layer having a constant distribution across an individual layer thickness. The gradient may be achieved with the aid of a multi-layer thin film composition in which a constant distribution of reactant and pore volume across the individual layer thickness is present in each layer. The individual layers may differ in their composition so that an effective porosity degree is formed along the total layer thickness. In this way, a local clogging of the electrode in the vicinity of the wall may be prevented and a higher charging or discharging rate may be achieved at a predefined charging and/or discharging capacity, or a higher charging and/or discharging capacity may be achieved at a given charging or discharging rate of the electrode.

It is advantageous when the reactant of the electrode is oxygen. By using oxygen, a lithium-oxygen or lithium-air electrode may be made available. In this way, a higher energy density may be implemented in the electrochemical energy store. Moreover, by using oxygen as the reactant, the total weight of the electrode may be reduced since, for example, the oxygen from the ambient air serves as the reaction partner of the lithium, whereby the reactant in the electrode does not need to be added during the manufacture. In this embodiment, no reactant is added. The preferred volume fraction of the conductive additive is 15 vol. % to 40 vol. %, supported on a porous metal structure (e.g., metal foam) as a carrier, if necessary. The preferred volume fraction of the binding agent is 4% to 10%. The remainder of the electrode is preferably pore space.

In one further advantageous embodiment, the reactant is sulfur. In this way, an electrochemical energy store having a lithium-sulfur electrode may be made available. In this way, the electrochemical energy store may supply a high specific energy, which may be 2 to 4 times greater than in conventional lithium-ion batteries. Moreover, sulfur is an inexpensive and plentiful resource, so that the overall costs of the electrochemical energy store may be reduced by the use of sulfur. Furthermore, the use of harmful metals may be dispensed with, which are used in lithium-ion cathodes, for example, such as LiCoO2.

In one advantageous embodiment of the electrode, the electrode has a pore volume which in the charged state of the electrode has a uniform distribution across the coating thickness. The proportion of conductive additive may in particular increase as a result of a not explicitly predefined distribution from the wall in the direction of the current collector. A portion of the pore space may be filled with reactant, for example sulfur, it being possible in particular for the proportion of reactant to decrease as a result of a not explicitly predefined distribution from the wall in the direction of the current collector. In this way, a higher charging or discharging rate may be achieved at a predefined charging and/or discharging capacity, or a higher charging and/or discharging capacity may be achieved at a given charging or discharging rate of the electrode.

It is furthermore advantageous when the electrode has a pore volume which in the charged state of the electrode increases from the current collector in the direction of the wall, for example a separator. A portion of the pore space may be filled with reactant, for example sulfur. The volume fraction of reactant may in particular decrease as a result of a not explicitly predefined distribution from the wall in the direction of the current collector. In this way, a higher charging or discharging rate may be achieved at a predefined charging and/or discharging capacity, or a higher charging and/or discharging capacity may be achieved at a given charging or discharging rate of the electrode.

With respect to further features and advantages of the electrode according to the present invention, reference is hereby explicitly made to the explanations provided in conjunction with the energy store according to the present invention, the method according to the present invention for manufacturing an electrode, and the use according to the present invention of the energy store equipped with the electrode in an electrical device, and to the figures.

The present invention furthermore relates to an electrochemical energy store, in particular a lithium-ion battery, including at least one above-described electrode. In this way, a higher charging or discharging rate may be achieved at a predefined charging and/or discharging capacity, or a higher charging and/or discharging capacity may be achieved at a given charging or discharging rate of the electrochemical energy store.

With respect to further features and advantages of the energy store according to the present invention, reference is hereby explicitly made to the explanations provided in conjunction with the electrode according to the present invention, the method according to the present invention for manufacturing an electrode, and the use according to the present invention of the energy store equipped with the electrode in an electrical device, and to the figures.

A subject matter of the present invention furthermore relates to a method for manufacturing an above-described electrode for an electrochemical energy store, including at least the following step: stacking multiple layers of porous conductive structures on top of each other, the porosity of the stacked structures increasing from the current collector in the direction of the wall. The porosity gradient may be implemented in the partially discharged electrode in that a gradient of the solid fraction of the conductive additive of the electrode is created during the manufacture of the electrode, and in particular in such a way that the solid fraction of this conductive additive decreases from the current collector in the direction of the wall. This conductive additive may ensure both the electrical conductivity and the mechanical stability of the electrode. In addition to the conductive additive, the matrix may also include binding agents, for example PVDF, CMC, PS rubber and other inactive materials improving the stability.

In the case of lithium-sulfur electrodes, the electrode may additionally be made of the reactant sulfur and a liquid electrolyte in the charged state, the electrolyte filling the remaining pore space. In the partially discharged state, the sulfur may be completely dissolved in solution in the electrolyte in the form of polysulfides. The pore volume available for the electrolyte is predefined by the conductive additive in this state. The same applies for the products precipitating during further discharging, for example Li2S, and for the sulfur precipitating during recharging.

In the case of Li-air or Li-oxygen electrodes, the conductive additive makes the pore space for the electrolyte and the reaction products precipitating during discharging, for example Li2O2, available in the charged state.

In one advantageous embodiment of the method for manufacturing an above-described electrode, the stacking takes place in a multi-layer coating process. Each layer may have a constant distribution of reactant and pore volume across the individual layer thickness. The individual layers may differ in their composition so that an effective porosity degree is formed along the total layer thickness. In this way, a local clogging of the electrode in the vicinity of the wall, which is generally designed as a separator, may be prevented in the electrode manufactured with the aid of the method, and a higher charging or discharging rate may be achieved at a predefined charging and/or discharging capacity, or a higher charging and/or discharging capacity may be achieved at a particular charging or discharging rate of the electrode.

The multi-layer coating process advantageously includes at least the following steps: creating slurries, applying a first layer onto the current collector, drying the first layer, compressing the first layer with the aid of a calendering process, applying additional layers, each of the additional layers being applied individually and being dried individually, each of the additional layers being compressed less strongly than the preceding layer. The term slurry refers to a suspension, the suspension being a heterogeneous substance mixture made up of a liquid and solids finely distributed therein, which are suspended in the liquid using suitable units, for example agitators, dissolvers, fluid jets, wet grinding mills, and usually with the aid of additional dispersing agents, and maintained in the suspended state. With the aid of existing equipment, it is easily possible to generate a gradient on the electrode by using this method.

It is furthermore advantageous if also the fraction of conductive additive decreases from layer to layer, in addition to the decreasing calendering pressure, in the above-described method. In this way, a larger gradient of the active material may be generated in the discharged electrode on the current collector, whereby a local clogging of the electrode in the vicinity of the wall may be prevented in the electrode manufactured with the aid of the method, and a higher charging or discharging rate may be achieved at a predefined charging and/or discharging capacity, or a higher charging and/or discharging capacity may be achieved at a given charging or discharging rate of the electrode.

In one further advantageous embodiment of the multi-layer coating process, the coating process is carried out by adding a salt of a slurry formulation, the salt being insoluble for the creation of a paste, the salt being soluble in another solvent, the salt being dissolved away after stacking the multiple layers on top of each other. In this way, a porous structure is easy to manufacture, which is not damaged by the compressing since the salt forming the pores is subsequently dissolved away.

Advantageously, the amount of added salt is varied from layer to layer in the above-described method. In this way, the gradient of the conductive additive may be increased.

With respect to further features and advantages of the method according to the present invention, reference is hereby explicitly made to the explanations provided in conjunction with the current collector according to the present invention, the energy store according to the present invention, and the use according to the present invention of the energy store equipped with the current collector in an electrical device, and to the figures.

The subject matter of the present invention furthermore relates to the use of the electrochemical energy store having at least one above-described electrode in motor vehicle applications, other electromobilities, in particular in ships, two-wheelers, airplanes, stationary energy stores, power tools, entertainment electronics and/or household electronics. The term ‘other electromobilities’ describes any kind of vehicles and means of transportation which are able to use the electrochemically stored electrical energy of the energy store. The motor vehicle applications, other electromobilities, in particular ships, two-wheelers, airplanes, stationary energy stores, power tools, entertainment electronics and/or household electronics may represent electronic components which are able to use the electrochemically stored electrical energy of the energy store. By using an electrochemical energy store having an above-described electrode, it is possible to operate the motor vehicle applications, other electromobilities, in particular in ships, two-wheelers, airplanes, stationary energy stores, power tools, entertainment electronics and/or household electronics longer since maintenance or a replacement of the electrochemical energy store may take place later due to the gradient in the conductive additive of the electrode.

With respect to further features and advantages of the use according to the present invention, reference is hereby explicitly made to the explanations provided in conjunction with the electrode according to the present invention, the energy store according to the present invention, and the method according to the present invention for manufacturing a current collector, and to the figures.

### BRIEF DESCRIPTION OF THE DRAWINGS

FIG. 1 shows a schematic representation of the distributed phase components of an electrode from the related art across the coating thickness in the completely discharged state.

FIG. 2 shows a schematic representation of the distributed phase components of the electrode across the coating thickness of the cell in the charged state.

FIG. 3 shows a schematic representation of the distributed phase components of the electrode across the coating thickness of the cell in the charged state.

FIG. 4 shows a schematic representation of the distributed phase components of the electrode across the coating thickness of the cell in the discharged state.

FIG. 5 shows a schematic representation of the distributed phase components of the electrode across the coating thickness of the cell in the charged state.

FIG. 6 shows a schematic representation of the distributed phase components of the electrode across the coating thickness of the cell in the charged state.

FIG. 7 shows a schematic representation of the distributed phase components of the electrode across the coating thickness of the cell in the charged state.

FIG. 8 shows a schematic representation of the distributed phase components of the electrode across the coating thickness of the cell in the discharged state.

### DETAILED DESCRIPTION

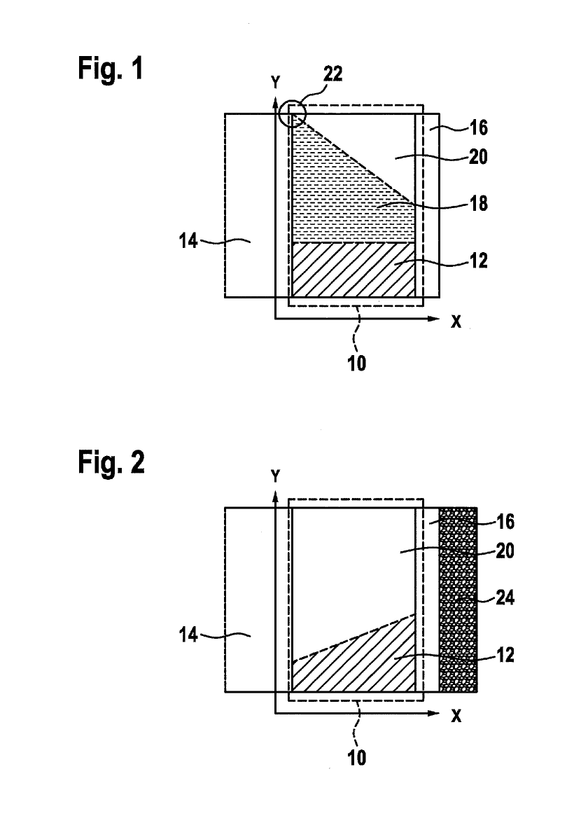

FIG. 1 shows a schematic representation of the distributed phase components (y axis) of the electrode of the related art across the coating thickness (x axis) in the completely discharged state. In this exemplary embodiment, the electrode is a cathode 10. Cathode 10 is highlighted by a dotted frame. As is apparent in FIG. 1, cathode 10 is situated between a wall 14, wall 14 being a separator in this exemplary embodiment, and a current collector 16. Current collector 16 is a metal foil made of copper in this exemplary embodiment. The sparingly soluble end product 18 of the reaction chain of electrochemical reactions, which is Li2S in this exemplary embodiment, preferably precipitates in the vicinity of wall 14 since the precipitation reaction takes place more quickly there due to the increased Li+ ion concentration than in the vicinity of current collector 16. Due to the uniformly distributed reactant 30 (not shown), reactant 30 being sulfur in this exemplary embodiment, or conductive additive 12 across the layer thickness, pore volume 20 increases from wall 14 in the direction of current collector 16. Pore volume 20 is filled by electrolyte and partially dissolved reactant 30. Conductive additive 12 furthermore has an electrically conductive matrix, which is graphite in this exemplary embodiment, and furthermore has mechanically stabilizing binding agents and additional inactive components, which are not shown. In FIG. 1, transition 22 from cathode 10 to wall 14 is circled; in the extreme case, clogging of the pores may take place, so that the electrochemical energy store is no longer usable and must be replaced.

FIG. 2 shows a schematic representation of the distributed phase components (y axis) of an electrode across the coating thickness (x axis) in the charged state. In this exemplary embodiment, the electrode is a cathode 10, and the electrochemical energy store is a lithium-air battery. Cathode 10 is framed in a dotted frame and situated between a wall and a current collector 16. Wall 14 is a separator in this exemplary embodiment. Cathode 10 includes a conductive additive 12, which is to be present in fiber form in this exemplary embodiment.

Cathode 10 furthermore includes a pore volume 20, which is filled by the electrolyte, partially dissolved reactant 30a, reactant 30a being oxygen in this exemplary embodiment, and a conducting salt containing Li+ ions, and conductive additive 12 furthermore includes mechanically stabilizing binding agents and additional inactive components, which are not shown. Current collector 16 is a porous metal sheet made of copper in this exemplary embodiment to allow the oxygen from the air to diffuse through in the direction of the cathode. A diaphragm 24 which is pervious to oxygen is situated next to current collector 16 so that oxygen from the ambient air is able to diffuse in the direction of cathode 10. Conductive additive 12 increases in particular as a result of a not explicitly predefined distribution from wall 14 in the direction of current collector 16.

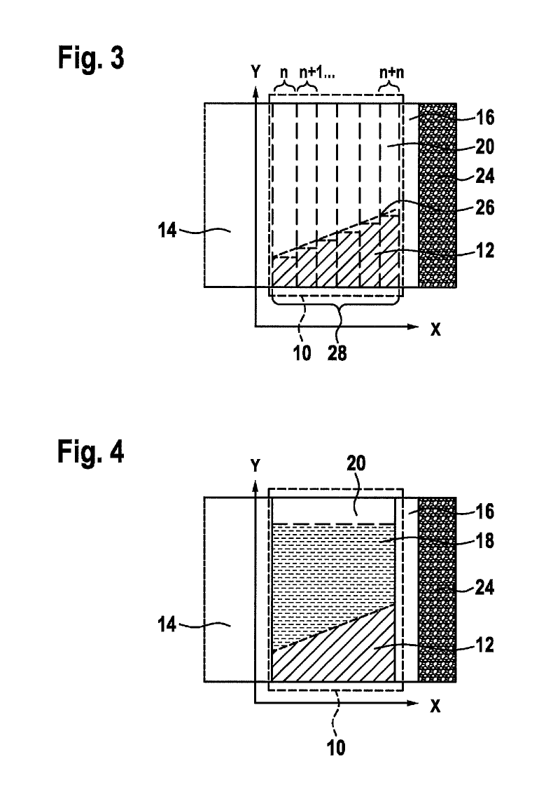

FIG. 3 shows a schematic representation of the distributed phase components (y axis) of the electrode across the coating thickness (x axis) in the charged state. In this exemplary embodiment, the electrode is a cathode 10, and the electrochemical energy store is a lithium-air battery. Cathode 10 is framed in a dotted frame and situated between a wall 14 and a current collector 16. Wall 14 is a separator in this exemplary embodiment. Cathode 10 includes a conductive additive 12, which is to be present in fiber form in this exemplary embodiment. Cathode 10 furthermore includes a pore volume 20, which is filled by the electrolyte, partially dissolved reactant 30a, the reactant being oxygen in this exemplary embodiment, and a conducting salt containing Li+ ions, the Li+ diffusing through wall 14 into cathode 10, and conductive additive 12 furthermore includes mechanically stabilizing binding agents and additional inactive components, which are not shown. The reactant Current collector 16 is a porous metal sheet made of copper in this exemplary embodiment to allow the oxygen from the air to diffuse through in the direction of the cathode. A diaphragm 24 which is pervious to oxygen is situated next to current collector 16. The generation of an effective reactant and/or porosity gradient 26 is achieved with the aid of a multi-layer composition, it being possible that each layer has a constant distribution of conductive additive 12 and/or inactive components across the individual layer thickness (n, n+1, . . . n+n). The effectively generated porosity gradient 26 is represented as a dotted line.

FIG. 4 shows a schematic representation of the distributed phase components (y axis) of the electrode across the coating thickness (x axis) in the discharged state. In this exemplary embodiment, the electrode is a cathode 10, and the electrochemical energy store is a lithium-air battery. Cathode 10 is framed in a dotted frame and situated between a wall and a current collector 16. Wall 14 is a separator in this exemplary embodiment. Cathode 10 includes a conductive additive 12, which is to be present in fiber form in this exemplary embodiment. Cathode 10 furthermore includes a pore volume 20, which is filled by the electrolyte, partially dissolved reactant 30a, reactant 30a being oxygen in this exemplary embodiment, and a conducting salt containing Li+ ions, the Li+ diffusing through wall 14 into cathode 10, and conductive additive 12 furthermore includes mechanically stabilizing binding agents and additional inactive components, which are not shown. Current collector 16 is a porous metal sheet made of copper in this exemplary embodiment to allow the oxygen from the air to diffuse through in the direction of cathode 10. A diaphragm 24 which is pervious to oxygen is situated next to current collector 16. The sparingly soluble end product 18 of the reaction chain of electrochemical reactions, which is Li2O2 in this exemplary embodiment, preferably precipitates in the vicinity of wall 14 since the precipitation reaction takes place more quickly there due to the increased Li+ ion concentration than in the vicinity of current collector 16. Due to the nonuniformly distributed conductive additive 12 and/or inactive components across the layer thickness, pore volume 20 remains uniformly distributed across the layer thickness. Cathode 10 is thus better utilized.

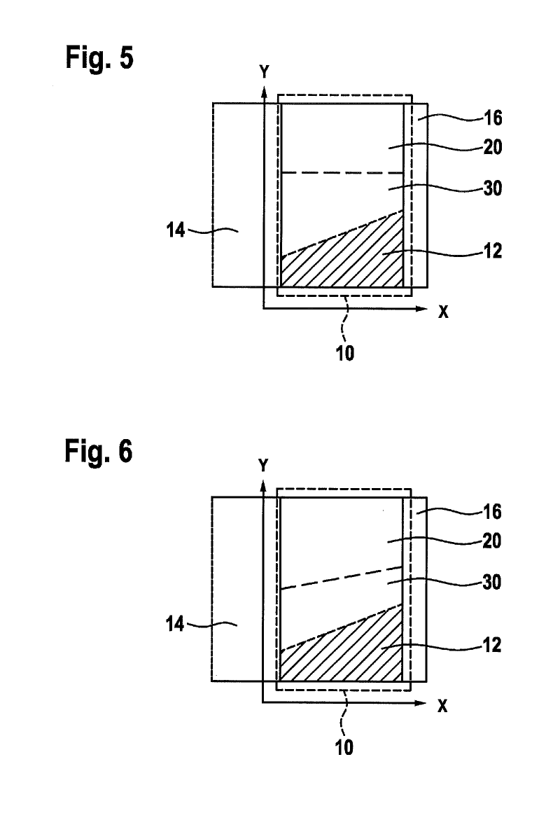

FIG. 5 shows a schematic representation of the distributed phase components (y axis) of the electrode across the coating thickness (x axis) in the charged state. In this exemplary embodiment, the electrode is a cathode 10, and the electrochemical energy store is a lithium-sulfur battery. Cathode 10 is framed in a dotted frame and situated between a wall and a current collector 16. Wall 14 is a separator in this exemplary embodiment. Cathode 10 includes a conductive additive 12, which is to be present in fiber form in this exemplary embodiment. Cathode 10 furthermore includes a pore volume 20, which is filled by the electrolyte, partially dissolved reactant 30, reactant 30 being sulfur in this exemplary embodiment, and a conducting salt containing Li+ ions, the Li+ diffusing through wall 14 into cathode 10, and conductive additive 12 furthermore includes mechanically stabilizing binding agents and additional inactive components, which are not shown. It is furthermore apparent that cathode 10 has a volume fraction of reactant 30, which is partially soluble in the electrolyte. Current collector 16 is a metal sheet made of copper in this exemplary embodiment. The volume fraction of conductive additive 12 increases in particular as a result of a not explicitly predefined distribution from wall 14 in the direction of current collector 16. The volume fraction of reactant 30 decreases in particular as a result of a not explicitly predefined distribution from wall 14 in the direction of current collector 16. As is apparent in FIG. 5, reactant 30 has a uniform pore volume distribution 24 across the coating thickness (x axis) in the charged state.

FIG. 6 shows a schematic representation of the distributed phase components (y axis) of the electrode across the coating thickness (x axis) in the charged state. In this exemplary embodiment, the electrode is a cathode 10, and the electrochemical energy store is a lithium-sulfur battery. Cathode 10 is framed in a dotted frame and situated between a wall 14 and a current collector 16. Wall 14 is a separator in this exemplary embodiment. Cathode 10 includes a conductive additive 12, which is to be present in fiber form in this exemplary embodiment. Cathode 10 furthermore includes a pore volume 20, which is filled by the electrolyte, partially dissolved reactant 30, reactant 30 being sulfur in this exemplary embodiment, and a conducting salt containing Li+ ions, the Li+ diffusing through wall 14 into cathode 10, and conductive additive 12 furthermore includes mechanically stabilizing binding agents and additional inactive components, which are not shown. It is furthermore apparent that cathode 10 has a volume fraction of reactant 30, which is partially soluble in the electrolyte. Current collector 16 is a metal sheet made of copper in this exemplary embodiment. The volume fraction of conductive additive 12 increases in particular as a result of a not explicitly predefined distribution from wall 14 in the direction of the current collector. The volume fraction of reactant 30 decreases in particular as a result of a not explicitly predefined distribution from wall 14 in the direction of current collector 16. The variant shown in FIG. 6 is characterized in the charged state by an increasing pore volume 20 across the electrode thickness from current collector 16 in the direction of wall 14.

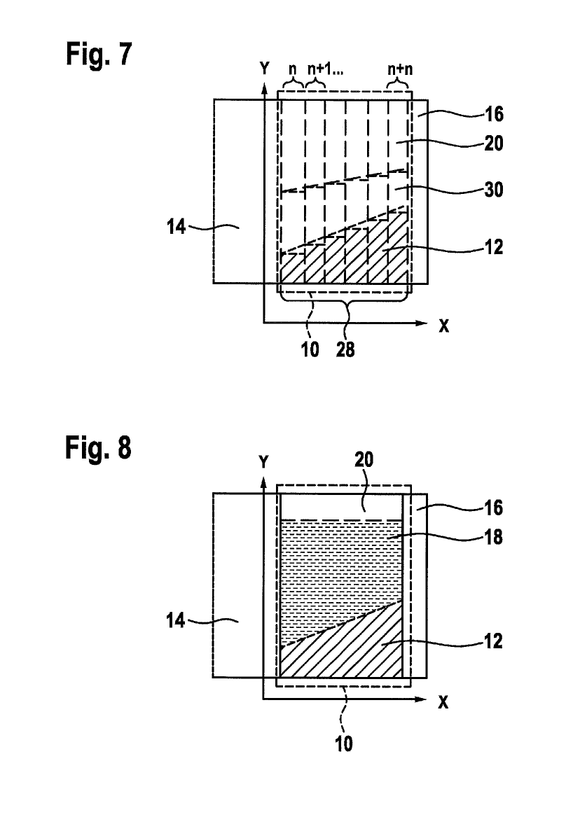

FIG. 7 shows a schematic representation of the distributed phase components (y axis) of the electrode across the coating thickness (x axis) in the charged state. In this exemplary embodiment, the electrode is a cathode 10, and the electrochemical energy store is a lithium-sulfur battery. Cathode 10 is framed in a dotted frame and situated between a wall 14 and a current collector 16. Wall 14 is a separator in this exemplary embodiment. Cathode 10 includes a conductive additive 12, which is to be present in fiber form in this exemplary embodiment. Cathode 10 furthermore includes a pore volume 20, which is filled by the electrolyte, partially dissolved reactant 30, reactant 30 being sulfur in this exemplary embodiment, and Li+ ions, the Li+ diffusing through wall 14 into cathode 10, and conductive additive 12 furthermore includes mechanically stabilizing binding agents and additional inactive components, which are not shown. It is furthermore apparent that cathode 10 has a volume fraction of reactant 30, which is partially soluble in the electrolyte. Current collector 16 is a metal sheet made of copper in this exemplary embodiment. The generation of an effective reactant and porosity gradient 28 may be achieved with the aid of a multi-layer composition, it being possible that each layer has a constant distribution of reactant 30 and conductive additive 12 across the individual layer thickness (n, n+1, . . . n+n).

FIG. 8 shows a schematic representation of the distributed phase components (y axis) of the electrode across the coating thickness (x axis) in the discharged state. In this exemplary embodiment, the electrode is a cathode 10, and the electrochemical energy store is a lithium-sulfur battery. Cathode 10 is framed in a dotted frame and situated between a wall 14 and a current collector 16. Wall 14 is a separator in this exemplary embodiment. Cathode 10 includes a conductive additive 12, which is to be present in fiber form in this exemplary embodiment.

Cathode 10 furthermore includes a pore volume 20, which is filled by the electrolyte, partially dissolved reactant 30 and a conducting salt containing Li+ ions, the Li+ diffusing through wall 14 into cathode 10, and furthermore includes mechanically stabilizing binding agents and additional inactive components, which are not shown. It is furthermore apparent that cathode 10 has a volume fraction of reactant 30, which is partially soluble in the electrolyte. Current collector 16 is a metal sheet made of copper in this exemplary embodiment. The sparingly soluble end product of the reaction chain of electrochemical reactions 18, this being Li2S in this exemplary embodiment, preferably precipitates in the vicinity of wall 14 since the precipitation reaction takes place more quickly there due to the increased Li+ ion concentration than in the vicinity of current collector 16. Due to the nonuniformly distributed reactant 30 or conductive additive 12 across the layer thickness, pore volume 20 remains uniformly distributed across the layer thickness. Cathode 10 is thus better utilized.

According to the present invention (not shown), a porosity gradient is implemented in the partially discharged electrode in that a gradient of the solid fraction in conductive additive 12 of the electrode is implemented during the manufacture of the electrode, and in particular in such a way that the solid fraction of conductive additive 12 decreases from current collector 16 in the direction of wall 14, which is a separator in this exemplary embodiment. This conductive additive 12 ensures both the electrical conductivity and the mechanical stability of the electrode. Conductive additive 12 may additionally also include binding agents and other inactive materials which improve the stability.

Such an electrode having a gradient in conductive additive 12 and the accompanying porosity gradient, which is available for the precipitation products, may be manufactured as follows, for example: In the case of a lithium-sulfur electrode, the conductive additive will be manufactured from multiple layers of porous conductive structures stacked on top of each other, which are either individually infiltrated with sulfur prior to stacking and/or may be infiltrated with sulfur in the stacked state. The infiltration preferably takes place with sulfur in the molten state or by deposition of sulfur from a solution. The vapor deposition of sulfur is also possible, for example with the aid of PVD or CVD. Possible porous stackable structures are particularly preferably carbon fabrics and/or carbon papers, which have a high porosity and good mechanical stability at the same time. These may be made of graphite, CNT or other carbon structures. Further preferred are other porous layers made of graphite, for example expanded graphite, and/or structures which were generated by printing carbon pastes together with a soluble salt and subsequently dissolving the salt away. Moreover, structures made of conductive polymers, for example PAN, may be used as fiber mats or in the form of stretched foils. Metallic fabrics and/or structures made of sintered metal fibers and/or metal particles may also be used. According to the present invention, the porous structure are stacked on top of each other in such a way that the porosity of the stacked structure increases from current collector 16 in the direction of wall 14.

In one further method, which is not shown, the electrode may be manufactured in a multi-stage coating process. For this purpose, slurries are prepared from at least carbon, for example graphite, carbon black, sulfur, binding agent and a solvent, which may have a differing ratio of the conductive additive to sulfur. Initially, a first layer is applied to current collector 16, this layer is subsequently dried and compressed the strongest in the subsequent calendering process. Additional layers may be applied thereon, which are also dried, but are then compressed less strongly than the preceding layer. To decrease the calendering pressure from layer to layer, additionally the fraction of conductive additive 12 may also decrease from layer to layer.

In one further method, which is not shown, the multi-stage coating process may also be carried out by adding a salt to the slurry formulation. The salt is insoluble in the solvent for the creation of a paste, but is soluble in another solvent. After completion of the coating process, the salt may also be dissolved away from the layer and thereby create additional porosity. The amount of added salt may vary from layer to layer.

In the case of the manufacture of Li-air or Li-oxygen electrodes, the same above-described methods may be used, however dispensing with sulfur.

The above-described electrode may be used in an energy store. The energy store may be used in motor vehicle applications, other electromobilities, in particular in ships, two-wheelers, airplanes and the like, stationary energy stores, power tools, entertainment electronics and/or household electronics.

1.-15. (canceled)

16. An electrode for an electrochemical energy store, the electrode being situated between a wall and a current collector, comprising:
at least one conductive additive; and
at least one reactant, wherein the electrode includes a gradient at which a volume fraction of the conductive additive decreases from the current collector in a direction of the wall.

17. The electrode as recited in claim 16, wherein the wall is a separator.

18. The electrode as recited in claim 16, wherein a volume fraction-based distribution of the conductive additive is achieved with the aid of a multi-layer composition, each layer having a constant distribution across an individual layer thickness (n, n+1, . . . n+n).

19. The electrode as recited in claim 16, wherein the reactant is oxygen.

20. The electrode as recited in claim 16, wherein the reactant is sulfur.

21. The electrode as recited in claim 20, wherein the electrode has a pore volume, the pore volume having a uniform distribution across a coating thickness in a charged state of the electrode.

22. The electrode as recited in claim 20, wherein the electrode has a pore volume, the pore volume increasing from the current collector in the direction of the wall in a charged state of the electrode.

23. An electrochemical energy store, comprising:
at least one electrode for an electrochemical energy store, the electrode being situated between a wall and a current collector, comprising:
at least one conductive additive; and
at least one reactant, wherein the electrode includes a gradient at which a volume fraction of the conductive additive decreases from the current collector in a direction of the wall.

24. The energy store as recited in claim 23, wherein the store includes a lithium-ion battery.

25. A method for manufacturing an electrode for an electrochemical energy store, the electrode being situated between a wall and a current collector, the electrode including at least one conductive additive; and at least one reactant, wherein the electrode includes a gradient at which a volume fraction of the conductive additive decreases from the current collector in a direction of the wall, the method comprising:
stacking multiple layers of porous conductive structures on top of each other, a porosity of the stacked structures increasing from the current collector in the direction of the wall.

26. The method as recited in claim 25, wherein the stacking is carried out in a multi-layer coating process.

27. The method as recited in claim 26, wherein the multi-layer coating process includes:
creating a slurry,
applying a first layer onto the current collector,
drying the first layer,
compressing the first layer with the aid of a calendering process,
applying additional layers, each of the additional layers being applied individually and being dried individually, and
compressing each of the additional layers less strongly than a preceding layer.

28. The method as recited in claim 27, wherein the volume fraction of conductive additive decreases from layer to layer, in addition to a decreasing calendering pressure.

29. The method as recited in claim 25, wherein the multi-layer coating process is carried out by adding a salt to a slurry formulation, the salt being insoluble for a creation of a paste, the salt being soluble in another solvent, the salt being dissolved away after stacking the multiple layers on top of each other.

30. The method as recited in claim 29, wherein an amount of added salt is varied from layer to layer.

31. A method of using an electrochemical energy store having at least one electrode, the electrode being situated between a wall and a current collector, and including at least one conductive additive; and at least one reactant, wherein the electrode includes a gradient at which a volume fraction of the conductive additive decreases from the current collector in a direction of the wall, the energy store being used in one of a motor vehicle application and another electromobility.

32. The method as recited in claim 31, wherein the other electromobility includes one of a ship, a two-wheeler, an airplane, a stationary energy store, a power tool, an entertainment electronics, and a household electronics.
